(19) United States
(12) Patent Application Publication
(10) Pub. No.: US 2009/0217823 A1
(43) Pub. Date: Sep. 3, 2009

(54) SYSTEM FOR PREPARING A PREDETERMINED AMOUNT OF BEVERAGE SUITABLE FOR CONSUMPTION, EXCHANGEABLE HOLDER, AND APPARATUS FOR SUCH A SYSTEM

(76) Inventors: Gerbrand Kristiaan De Graaff, Lisse (NL); Hendrik Cornelis Koeling, Amersfoort (NL); Ka Cheung Tsang, Amsterdam (NL); Ralf Kamerbeek, Utrecht (NL)

Correspondence Address: FOLEY & LARDNER LLP, 777 EAST WISCONSIN AVENUE, MILWAUKEE, WI, 53202-5306, US

(21) Appl. No.: 12/297,618

(22) PCT Filed: Apr. 19, 2007
(86) PCT No.: PCT/NL2007/050161

§ 371 Date: Jan. 29, 2009

(30) Foreign Application Priority Data
Apr. 19, 2006 (NL) 1031622
Jun. 29, 2006 (NL) 1032090

(51) Int. Cl. A47J 31/41; B67D 1/00

(52) U.S. Cl. 99/279; 222/145.5

(57) ABSTRACT

A system for preparing a predetermined amount of beverage suitable for consumption, provided with an exchangeable holder and an apparatus provided with a fluid dispensing device with an outlet opening which in use is detachably connected with an inlet opening of the holder for dispensing a first fluid under pressure to a first mixing chamber of the exchangeable holder. The exchangeable holder is provided with a stop against which a fluid supply element of the fluid dispensing device forming at least a part of the outlet opening abuts in use, such that in use the first fluid is supplied through the inlet opening of the holder into the first mixing chamber and then, along a certain path within the first mixing chamber, does not hit any inner walls of the first mixing chamber.

The invention relates to a system for preparing a predetermined amount of beverage suitable for consumption, provided with an exchangeable holder and an apparatus provided with a fluid dispensing device which is detachably connected with the holder for in use dispensing under pressure at least an amount of first fluid such as a liquid and/or a gas, in particular such as water and/or steam, to the exchangeable holder, wherein the exchangeable holder is provided with at least one storage space which is filled with a second fluid such as a concentrate, wherein the holder is further provided with at least a first mixing chamber, at least one outflow opening which is in fluid communication with the first mixing chamber for dispensing the beverage from the first mixing chamber, wherein in use at least one fluid communication between the storage space and the first mixing chamber for dispensing the second fluid to the first mixing chamber is present, wherein the holder comprises at least one inlet opening which in use is detachably connected with an outlet opening of the fluid dispensing device for supplying the first fluid to the first mixing chamber, wherein the fluid dispensing device is arranged for supplying the first fluid under pressure to the first mixing chamber, so that in the first mixing chamber the first fluid and the second fluid mix together for obtaining beverage which thereupon leaves the exchangeable holder via the outflow opening.

Such a system is known.

In the known system, the apparatus is provided with a fluid dispensing device with an outlet opening which can be detachably connected with the inlet opening of the exchangeable holder for dispensing the first fluid to the first mixing chamber. In use, after connecting the outlet opening with the inlet opening, the first fluid is spouted into the first mixing chamber, where this fluid mixes with a second fluid which is for instance already present in the first mixing chamber or is introduced into the first mixing chamber simultaneously with the first fluid.

A disadvantage of the known system is that the discharge opening of the nozzle can only be positioned inaccurately, or with little accuracy, in front of the inlet opening of the holder, so that the first fluid, in use, is inaccurately supplied from the fluid dispensing device into the first mixing chamber. As a result, it is possible that the first fluid chiefly hits an inner wall of the first mixing chamber adjacent the inlet opening of the first mixing chamber. The first fluid will then flow along an inner wall as the first mixing chamber is being filled. In this way, no optimum mixing of the first and the second fluid is obtained, so that the beverage eventually prepared does not possess the desired properties or quality.

The object of the invention is to provide a system with which this disadvantage can be prevented. More specifically, the object of the invention is to provide a system in which the discharge opening of the fluid dispensing device can be positioned accurately before the inlet opening of the holder, whereby in use the first fluid can be supplied into the first mixing chamber in a desired manner, whereby a proper mixing of the first and the at least second fluid is obtained.

To achieve this objective, the holder of the system according to the invention is further provided with a stop against which a fluid supply element of the fluid dispensing device forming at least a part of the outlet opening abuts in use, such that in use the first fluid is supplied through the inlet opening of the holder into the first mixing chamber and then, along a certain path within the first mixing chamber, does not hit any inner walls of the first mixing chamber. By means of such a stop, the fluid supply element forming at least a part of the outlet opening, upon each renewed use of the system, is positioned in the same manner before the inlet opening of the holder. In use, the outlet opening comes to lie in the desired position before the inlet opening of the holder, after which the fluid dispensing device can supply the first fluid under pressure to the first mixing chamber. Since during the supply of the first fluid to the first mixing chamber the fluid, along a certain path within the first mixing chamber, does not hit any inner walls of the first mixing chamber, the first fluid forms a jet which ends up with a particular speed in the first mixing chamber. Because the jet, after traversing the certain path, strikes an inner wall somewhere in the first mixing chamber with a particular speed, this jet will be rebounded, which causes whirls in the first and/or second fluid, which promotes a proper mixing. Preferably, in use, the outlet opening is situated before the inlet opening of the holder, while using the outlet opening a jet of the first fluid is formed which spouts direct into the first mixing chamber. According to a further elaboration of the invention, the inlet opening of the holder preferably also forms an inlet opening of the first mixing chamber.

The certain path which the first fluid travels in the first mixing chamber preferably has a length of at least one-third of a length of the first mixing chamber viewed in a direction of the entering fluid. This minimum length of the certain path provides for a better rebound, resulting in better whirls for further promoting a proper mixing of the beverage. Also, the minimum length of the certain path ensures that air can be drawn into the jet of the first fluid, so that an airy beverage or a beverage provided with a froth layer can be prepared. The above-mentioned inner wall is preferably an inner wall of the first mixing chamber that is situated opposite the inlet opening of the first mixing chamber, which inner wall of the first mixing chamber is first hit by the entering first fluid. Preferably, the inner wall extends substantially perpendicularly to the direction of the path which the entering first fluid follows within the first mixing chamber. Such an inner wall receives the jet of the first fluid that is spouted into the first mixing chamber with a particular speed, whereby the inner wall provides for the rebound of the jet, which further promotes turbulence in the first fluid, the second fluid and/or the beverage.

In a further elaboration of the invention, the stop extends substantially parallel between a first wall bounding the first mixing chamber and a second wall, situated opposite the first wall, bounding the first mixing chamber, while preferably a distance from the stop to the first wall and a distance from the stop to the second wall are substantially equal, or a distance from a plane through the stop to a plane through the first wall is substantially equal to a distance from the plane through the stop to a plane through the second wall.

Such a positioning of the stop provides that the outlet opening of the fluid supply element is favorably situated relative to both the first and the second wall bounding the mixing chamber at the time of supply of the first fluid to the first mixing chamber, so that the chance of the fluid hitting an inner wall of the first mixing chamber adjacent the inlet opening is further reduced. Also in the event of small tolerances in the dimensions of the exchangeable holder, for instance in the thickness of the stop, the outlet opening will be positioned relative to the inlet opening such that the first fluid, even then, is supplied to the first mixing chamber without hitting the inner walls along the certain path.

According to a further elaboration of the invention, the outlet opening is formed at least for a part by the fluid supply element, provided on the apparatus, having a first fluid channel, while in use adjacent an end of the fluid channel a first nozzle is provided for dispensing the first fluid. Such a nozzle accomplishes a desired shape of the jet of fluid, the behavior of the jet of fluid being determined by the nozzle, so that no unexpected deflection or otherwise unwanted direction of entry of the jet of fluid occurs. Also, by varying the diameter of the nozzle, the kind of jet can be determined, for instance a strong jet or a mist. In this way, the first fluid is spouted into the inlet opening in a manner desired for the beverage to be prepared.

According to a further elaboration of the invention, the first nozzle may be formed at least for a part by a groove and/or channel provided in a side of the stop situated opposite the fluid supply element, substantially transversely to the fluid channel, while the groove and/or the channel extends from the fluid channel to the inlet opening. Such a nozzle is simple to manufacture because it is manufactured with the exchangeable holder. Further, such a nozzle does not need to be cleaned since, along with the exchangeable holder, it is taken from the system after preparation of the beverage. For a next beverage to be prepared, a new nozzle is used which is provided in the new exchangeable holder.

In another elaboration of the invention, the first nozzle may be formed at least for a part by a groove, which is provided in a side of the fluid supply element situated opposite the stop, substantially transversely to the fluid channel, and a side of the stop situated opposite the fluid supply element, while the groove extends from the fluid channel as far as an outermost side of the fluid supply element. Such a nozzle is relatively easy to clean. What is also accomplished by this construction of the nozzle is that instances of clogging of the nozzle are comparatively rare. Such a nozzle provides that with each exchangeable holder, the first fluid is spouted from the fluid supply element into the first mixing chamber in the same manner.

In a further elaboration of the invention, the stop comprises an abutment surface which has substantially an equal shape and equal dimensions to the side of the fluid supply element situated opposite the stop. Thus, the fluid supply element fits onto the stop in just a single manner and/or position, which further promotes accurate positioning of the nozzle relative to the inlet opening of the first mixing chamber.

According to a further elaboration of the invention, the stop is provided with a notch or a protrusion, which notch or protrusion is situated substantially opposite the groove in the side of the fluid supply element situated opposite the stop and substantially connects to circumferential edges of the groove for forming a larger or a smaller nozzle, respectively. Through such a notch or protrusion that may be provided in the exchangeable holder, the diameter of the nozzle can be adjusted. In this way, it is possible to supply more or less fluid to the first mixing chamber during a same unit of time. For instance, in preparing a particular beverage, it may be desired to supply more fluid to the first mixing chamber in a shorter period than when preparing a different beverage. Owing to the notch, or the protrusion, being provided in the exchangeable holder, always the right nozzle is formed that is needed for the concentrate present in the holder, for preparing the associated beverage.

In a further elaboration of the invention, the system is provided with at least one gas supply opening which is, or can be set, in fluid communication for supplying gas, such as air or CO₂, to the beverage in the system. Such a gas supply opening is for instance favorable for preparing a beverage with a fine-bubble froth layer or, for instance, a carbonated beverage. Preferably, such a gas supply opening can be formed by a second fluid channel provided in the fluid supply element, with the first fluid channel being arranged for supplying the first fluid, for instance water or steam, while the second fluid channel is arranged for supplying gas, for instance air or CO₂.

In a further elaboration of the invention, an end of the second fluid channel is situated substantially above an end of the first nozzle in an outermost sidewall of the fluid supply element viewed from the side of the fluid supply element situated opposite the stop. If the fluid supply element is placed on the stop in the proper manner, both the first fluid, for instance hot water, and simultaneously also air can be supplied to the first mixing chamber. In this way, for instance a frothy hot cocoa can be prepared if a cocoa concentrate is provided in the storage space.

According to a further elaboration of the invention, slidably around the fluid supply element, a closing means is provided, which closing means is slidable from an open position in which the end of the second fluid channel and the end of the first nozzle are open, to a closed position in which one of the ends is closed to supply only the first fluid to the first mixing chamber or to supply only gas, such as air or CO₂, to the first mixing chamber, respectively. According to a further elaboration of the invention, it is then preferred that the stop is provided with a cam, the cam being arranged to bring the closing means in use to a desired position and to keep it in a desired position. Depending on the kind of concentrate comprised by the exchangeable holder, for instance, there may or may not be a cam provided on the stop. If the concentrate merely requires that, in preparing the beverage, water be supplied to the concentrate, the cam on the stop will be arranged such that the outlet opening is closed to air. If both air and water are to be added to the concentrate, no cam will be provided on the stop of the exchangeable holder, or, for instance, a cam which is arranged such that the end of the second fluid channel and the end of the first nozzle are open.

In another embodiment of the invention, an end of the second fluid channel may be situated in the same plane in which the first fluid channel extends and be situated adjacent the end of the first fluid channel. It is possible that, according to a further elaboration of the invention, an end of the second fluid channel is in fluid communication with the first nozzle. Both the first fluid, for instance the hot water, and the air are supplied to the first mixing chamber via the same nozzle. Here, the stop, in a further elaboration of the invention, can comprise a closing cam which in use at least partly closes the fluid communication between the second fluid channel and the first nozzle. This closing cam may for instance be provided if only the first fluid is desired for preparing the beverage, for instance tea, where no froth layer is desired.

In a further embodiment of the invention, adjacent the end of the second fluid channel, a second nozzle is provided for dispensing gas, such as air or CO₂, to the first mixing chamber. According to a further elaboration of the invention, the second nozzle may be formed at least for a part by a groove and/or channel, provided in a side of the stop situated opposite the fluid supply element, substantially transversely to the second fluid channel, while the groove and/or the channel extends from the second fluid channel to the inlet opening, while the first and second nozzles are situated substantially next to each other viewed from the side of the stop situated opposite the fluid supply element. The second nozzle, too, like the first nozzle when it is manufactured in this way, is replaced when exchanging the holder.

It is also possible, according to a further elaboration of the invention, that the second nozzle is formed at least for a part by a groove, which is provided in a side of the fluid supply element situated opposite the stop, substantially transversely to the second fluid channel, and a side of the stop situated opposite the fluid supply element, while the groove extends from the fluid channel as far as an outermost side of the fluid supply element, while the nozzles are situated substantially next to each other, viewed from the side of the fluid supply element situated opposite the stop. The second nozzle, too, is easy to manufacture in this way and also easy to clean, which is favorable to hygienic aspects of the system.

In a further elaboration of the invention, rotatably about the fluid supply element, a closing means may be provided which is rotatable from an open position, in which an end of the second nozzle and an end of the first nozzle are open, to a closed position, in which one of the ends is closed to supply only the first fluid to the first mixing chamber or to supply only gas, such as air or CO₂, to the first mixing chamber, respectively. Such a closing means works in a same manner as the slidable closing means mentioned earlier. This closing means, too, can be positioned such that, for instance depending on the concentrate in the exchangeable holder, only the first fluid can be supplied, only air can be supplied or both can be supplied to the first mixing chamber simultaneously.

According to a further elaboration of the invention, the stop comprises at least one of a notch and/or a protrusion which in use is situated opposite at least one of the grooves of the first and second nozzles, while the at least one notch and/or protrusion substantially connects to circumferential edges of the respective grooves for respectively enlarging, reducing or closing the at least one nozzle. Such notches and/or protrusions provide an enlarged or reduced nozzle which, depending on the kind of concentrate in the holder, supplies a desired quantity of first fluid and/or gas in a particular unit of time to the first mixing chamber. Depending on the beverage to be prepared, the magnitude, more in particular the diameter of the nozzle, can be determined. If for instance the second fluid is a coffee concentrate and the first fluid is hot water and a cup of coffee with a slight froth layer is to be prepared, the second nozzle can be chosen to be relatively small by providing for instance a relatively large protrusion on the stop opposite the second nozzle. For instance for preparing a frothy cocoa from a cocoa concentrate and hot water, the second nozzle can be relatively large, for instance with a comparable diameter to the first nozzle. A large amount of air is then supplied to the first mixing chamber simultaneously with the hot water, so that the first and the second fluid mix and simultaneously are provided with much air in order to obtain the frothy composition.

Further, for preparing the beverage, a user of the system does not need to perform any extra operations to regulate the supply of the first fluid and/or the gas, such as air, to the first mixing chamber, since this is automatically done by the construction of the stop.

According to a further embodiment of the invention, between the side of the fluid supply element situated opposite the stop, and the side of the stop situated opposite the fluid supply element, a sealing is provided. Such a sealing forms a fluid-tight closure between the fluid supply element and the first mixing chamber and prevents leakage of the first fluid and/or air to other parts of the apparatus. Also, no loss of the fluid occurs during the supply of the fluid to the first mixing chamber. In this way, an accurate dosing of the first fluid is ensured, so that the beverage obtains the desired concentration.

In a further elaboration of the invention, the sealing comprises at least one sealing groove and a sealing edge fitting into the sealing groove, while the sealing groove extends adjacent the circumferential edge of the side of the fluid supply element situated opposite the stop and the sealing edge extends adjacent the circumferential edge of the side of the stop situated opposite the fluid supply element, or vice versa. In use, when the fluid supply element has been placed on the stop, the sealing edge falls into the sealing groove, thereby forming the sealing.

According to a further elaboration of the invention, the system may be provided with a control device for controlling the fluid dispensing device. Such a control device can for instance be arranged such that the fluid dispensing device independently supplies the first fluid and the gas to the first mixing chamber. Thus, for instance, first the first fluid may be supplied and after that an amount of air. It is also possible, however, that the fluid dispensing device is controlled to supply the first fluid and the air simultaneously. It is clear that also a different order of supply of the first fluid and air can be effected by the control.

In a further elaboration of the invention, the stop is rigid. Such a stop has as an advantage that the stop does not deform when the fluid supply element is placed on it, which limits deviations in the positioning of the outlet opening relative to the inlet opening of the first mixing chamber. In another embodiment of the invention, in use, under the stop, a retainer member is provided, such that when the fluid supply element is situated on the stop, the stop cannot deform. When the stop is not rigid, the retainer member can be placed under the stop, such that the stop retains its shape when the fluid supply element is placed on it. In this way, too, deviations in the positioning of the outlet opening relative to the inlet opening will be limited.

The invention further relates to an exchangeable holder arranged to be connected with an apparatus provided with a fluid dispensing device for in use dispensing under pressure at least a first fluid such as a gas and/or liquid to the exchangeable holder for preparing a beverage suitable for consumption, wherein the exchangeable holder is provided with at least one storage space which is filled with a second fluid such as a concentrate, wherein the holder is further provided with at least a first mixing chamber, at least one outlet opening which is in fluid communication with the first mixing chamber for dispensing the beverage from the first mixing chamber, wherein in use at least one fluid communication between the storage space and the first mixing chamber for dispensing the second fluid to the first mixing chamber is present, wherein the holder comprises at least one inlet opening which, in use, is detachably connected with an outlet opening of the fluid dispensing device for supplying the first fluid to the first mixing chamber, wherein the fluid dispensing device is designed for supplying the first fluid under pressure to the first mixing chamber, so that in the first mixing chamber the first fluid and the second fluid mix together for obtaining the beverage which thereupon leaves the exchangeable holder via the outflow opening, wherein the holder is further provided with a stop against which a fluid supply element of the fluid dispensing device forming at least a part of the outlet opening abuts in use, such that in use the first fluid is supplied through the inlet opening of the holder into the first mixing chamber and then, along a certain path within the first mixing chamber, does not hit any inner walls of the first mixing chamber.

Such an exchangeable holder has the same advantages and effects as those mentioned in connection with the system described above.

Finally, the invention relates to an apparatus for use in a system as described above. Such an apparatus provides equal advantages to those mentioned in connection with the above-described system.

Further advantageous embodiments of the invention are set forth in the dependent claims.

The invention will now be further elucidated with reference to the drawing, in which

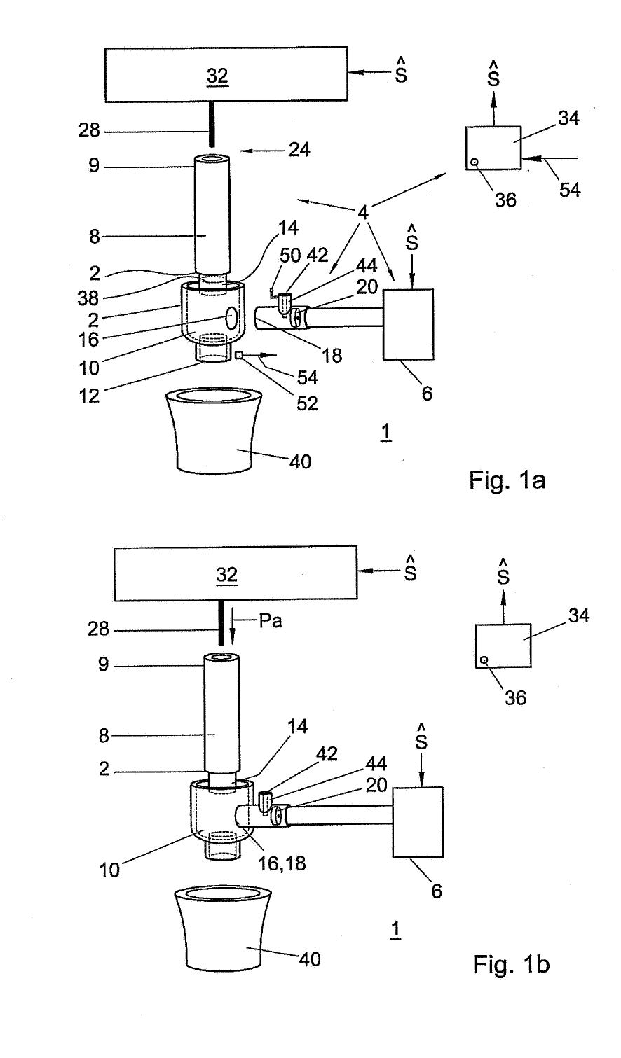

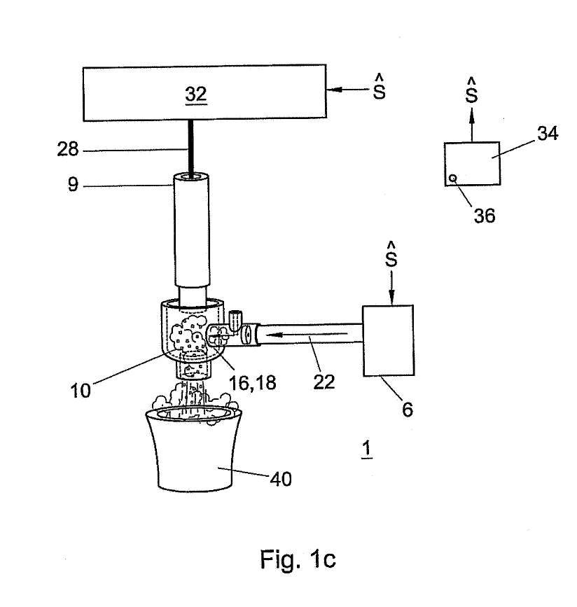

FIG. 1a shows a first embodiment of a system for preparing a predetermined amount of beverage suitable for consumption;

FIG. 1b shows the system according to FIG. 1a in operational condition;

FIG. 1c shows the system according to FIG. 1a in operational condition;

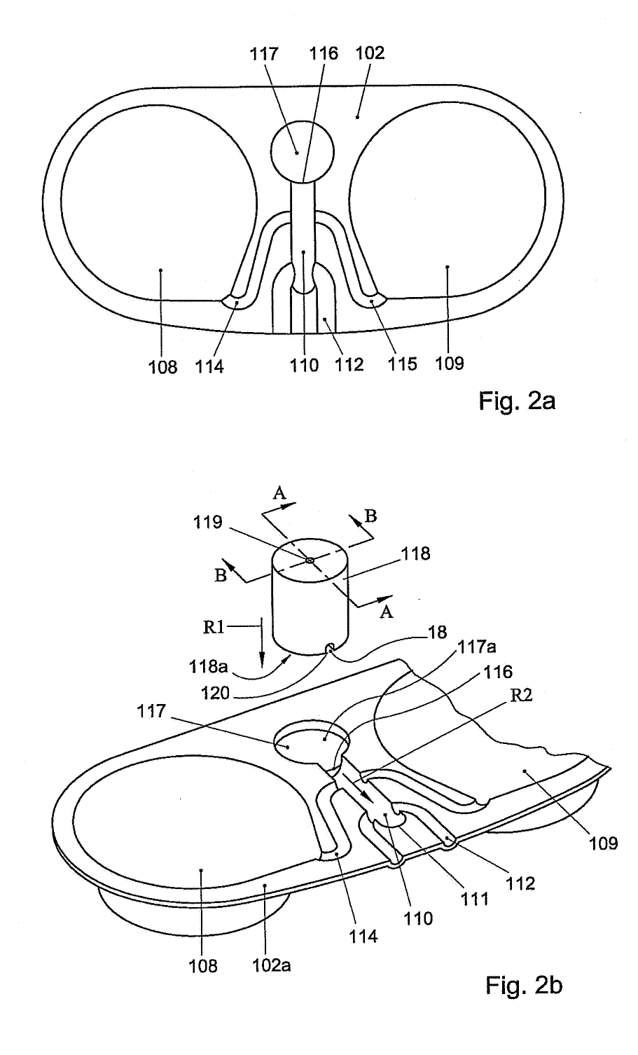

FIG. 2a shows a top plan view of an exchangeable holder;

FIG. 2b shows a partly perspective view of the exchangeable holder from FIG. 2a and the fluid supply element;

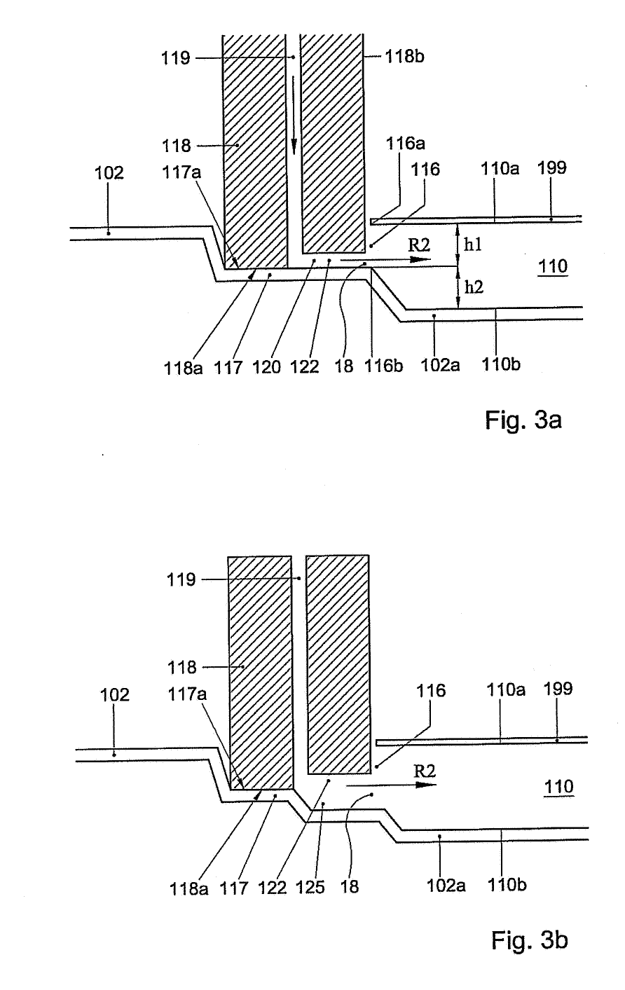

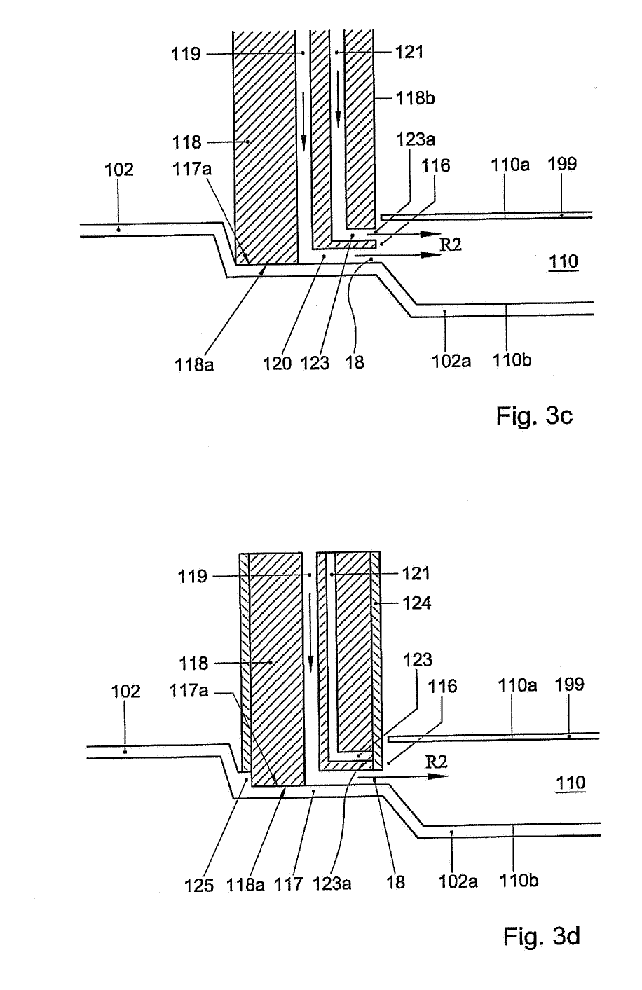

FIGS. 3a-3d schematically show cross sections A-A′ of different embodiments of the holder and the fluid supply element from FIG. 2b;

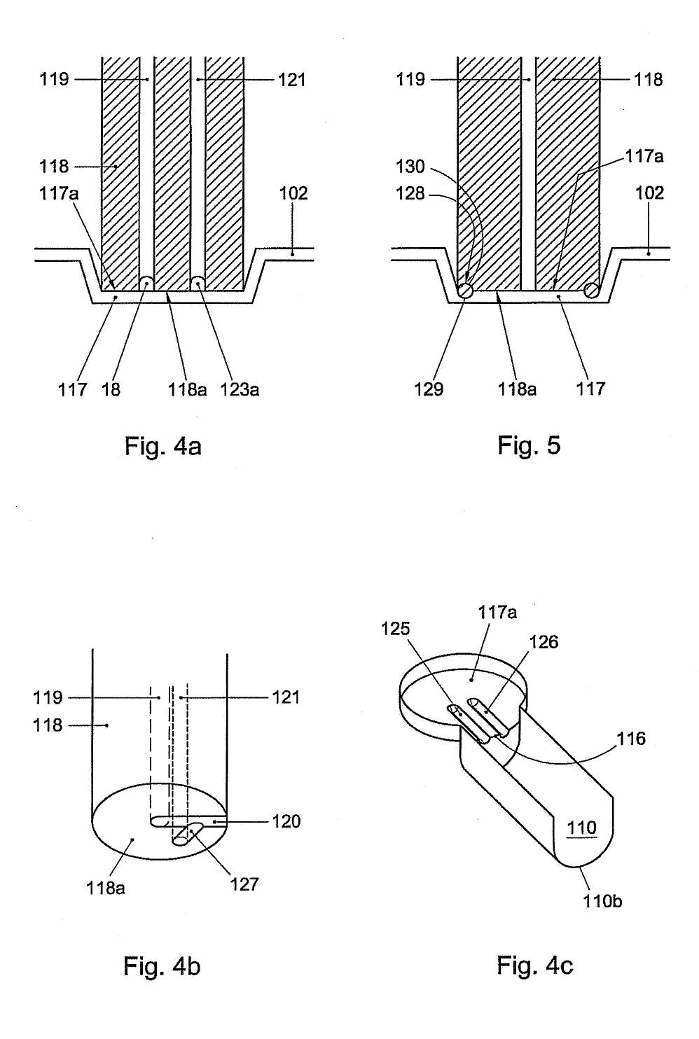

FIG. 4a shows a schematic cross section B-B′ of an embodiment of the holder and the fluid supply element from FIG. 2b;

FIG. 4b shows a perspective bottom view of a fluid supply element;

FIG. 4c shows a perspective view of a part of the holder; and

FIG. 5 shows a schematic cross section B-B′ of an embodiment of the holder and the fluid supply element from FIG. 2b.

Reference is first made to FIGS. 1a-1c. In FIG. 1, reference numeral 1 designates a system for preparing a predetermined amount of beverage suitable for consumption. The system (see FIG. 1a) is provided with an exchangeable holder 2. It is noted that an embodiment of the holder 2 will be described in more detail later, with reference to FIGS. 2a-b, 3a-d, 4a-b and 5. The system 1 is further provided with an apparatus 4 which is provided with, inter alia, a fluid dispensing device 6 arranged for dispensing, under pressure, at least one amount of at least a first fluid such as a liquid and/or a gas, more particularly such as water and/or steam. In this example, in use, the fluid dispensing device 6 dispenses water. The fluid dispensing device 6 will also be described in more detail later, as will the cooperation of the fluid dispensing device 6 with the exchangeable holder 2. In FIGS. 1a-1c, for the purpose of the initial description of the system and its operation, the holder 2 and the fluid dispensing device 6 are as yet only represented in a highly schematic manner.

The exchangeable holder 2 is provided with at least one storage space 8, which is filled with a second fluid, such as a beverage, a concentrate or a powder. In this example, the storage space 8 is formed by a rigid wall. However, this is not requisite. In this example, a concentrate for preparing coffee is involved. The holder 2 is further provided with at least a first mixing chamber 10 and at least one outflow opening 12, which is in fluid communication with the first mixing chamber 10. The holder 2 is further provided with a fluid communication 14 between the storage space 8 and the first mixing chamber 10. The holder 2 is furthermore provided with at least one inlet opening 16, which is detachably connected with an outlet opening 18 of the fluid dispensing device 6. In FIG. 1a, the inlet opening 16 has not yet been connected with the outlet opening 18, while in FIG. 1b it has been connected. In this example, the inlet opening 16 in FIG. 1a is still closed off by a closure that can be removed, such as a removable seal. This also holds for the outflow opening 12. In use, both removable seals are removed whereupon the outlet opening 18 can be connected with the inlet opening 16 as shown in FIG. 1b.

In this example, the system is further provided with a restriction 20 which is included in a fluid flow path 22 which extends, via the outlet opening 18 of the fluid dispensing device 6, the inlet opening 16 and the first mixing chamber 10, from the fluid dispensing device 6 to the outflow opening 12.

More particularly, it holds in this example that the restriction 20 is included in a fluid flow path 22 which extends, via the outlet opening 18 of the fluid dispensing device 6 and the inlet opening 16 of the exchangeable holder 2, from the fluid dispensing device 6 to the first mixing chamber 10.

The storage space 8 forms at least a part of a dosing device 24 as will be further explained hereinafter. In this example, this dosing device 24 is further provided with a needle 24 which, in use, is pierced through a wall of the storage space 8 for supplying a third fluid to the second fluid in the storage space 8 for dispensing the second fluid in a dosed manner to the first mixing chamber 10. In this example, the dosing device 24 is further provided with a fluid dispensing unit 32 which is connected to the needle 28. The fluid dispensing unit 32 and the needle 28 form part of the apparatus 4. The fluid dispensing unit 32 is detachably connected, in this example at least via the needle 28, with the holder 2.

The apparatus 4 is further provided with a control device 34 for controlling the fluid dispensing device 6 and the fluid dispensing unit 32. To control the fluid dispensing device 6 and the fluid dispensing unit 32, the control device 34 generates control signals ŝ which are supplied to the fluid dispensing device 6 and the fluid dispensing unit 32. In this example, the control device 34 is designed for controlling the fluid dispensing device 6 and the fluid dispensing unit 32 independently of each other.

The system 1 described up to this point works as follows. For the purpose of preparing a predetermined amount of beverage suitable for consumption, the exchangeable holder 2 is placed in the apparatus 4. Here, the storage space 8 of the exchangeable holder 2 is placed under the needle 28. Also, as shown in FIG. 1b, the outlet opening 18 is connected to the inlet opening 16. The apparatus is now ready for use. For instance by pushing a button 36 of the control device 34, the control device causes the fluid dispensing unit 32 to move the needle 28 in the direction of the arrow Pa. As a result, the needle 28 is pierced through a wall of the storage space 8 and the third fluid is supplied under pressure to the second fluid in the storage space. As a result, the third fluid will apply a pressure and/or force to the second fluid. As a result, in this example, the pressure in the storage space 8 will increase. Here, the fluid communication 14 may for instance be provided with a sealing 38, for instance in the form of a breakable membrane 38 which, as a result of the increase of the pressure in the storage space 8 resulting from the supply of the third fluid, tears open. As a result, in this example, the coffee concentrate will flow in a dosed manner from the storage space 8 via the fluid communication 14 to the first mixing chamber 10. Simultaneously, the control device 34 causes the fluid dispensing device 6 to be activated. This has as a result that the fluid dispensing device 6 starts to dispense the first fluid, in this example water, under pressure. In this example, this water is hot water with a temperature of, for instance, 80-98° C. This hot water flows via the fluid flow path 22 to the restriction 20. Having arrived at the restriction 20, by means of the restriction 20 a jet of the hot water is generated. This jet spouts via the outlet opening 18 and the inlet opening 16 into the first mixing chamber 10. In the first mixing chamber 10, the hot water will start mixing well with the concentrate. Here, the flow rate at which the concentrate is supplied to the first mixing chamber 10 is regulated by the control device 34, through control of the fluid dispensing unit 32. Further, the flow rate at which the hot water is supplied to the first mixing chamber 10 is also regulated by the control device 34 through control of the fluid dispensing device 6. In the first mixing chamber, as a result of the jet, the concentrate will mix well with the hot water, so that the beverage is formed. This beverage can then leave the outflow opening 12 and be captured in, for instance, a cup 40.

Since in the system 1 according to the invention both the dosing of the concentrate over time and the dosing of the hot water over time can be regulated well, it can be provided that the concentration of the amount of concentrate in the beverage can be accurately determined. Furthermore, it can be provided that the beverage which, during its preparation, leaves the outflow opening 12, is of constant quality, i.e., the concentration of the concentrate in the beverage that is dispensed can be kept substantially constant during dispensing, if so desired. The fact is that in this example, the flow rate of the water and the flow rate of the concentrate that are supplied to the first mixing chamber 10 can each, if so desired, be controlled independently of each other. Therefore, it holds in this example, that the system 1 is designed such that the fluid dispensing device 6 and the dosing device 24 can supply, independently of each other, the first fluid and the second fluid, respectively, to the first mixing chamber 10. This implies that the magnitude of the flow rate of the first fluid and the period during which the first fluid is dispensed are independent (in this example through control of the control device) of the magnitude of the flow rate of the second fluid and the period during which the second flow is dispensed.

It further holds in this example that the dosing device 24 is a controllable and active dosing device for supplying the second fluid to the first mixing chamber by applying an increased pressure or force to the second fluid. Herein, an active dosing device is understood to mean that the second fluid flows through the fluid communication from the storage space to the first mixing chamber as a result of an excess pressure or force applied on the side of the storage space.

In the example, the system 1 is further provided with an air inlet opening 42. The air inlet opening 42 ensures that air is supplied to the first mixing chamber 10 so that, in use, air is beaten into the beverage for obtaining a beverage with a fine-bubble froth layer. Thus, a café crème can be obtained. In this example, the air inlet opening 42 is in fluid communication with the first mixing chamber 10 downstream of the restriction 20. In this example, the air inlet opening 42 terminates, via a fluid communication 44, in the fluid flow path 22. In this example it therefore holds that the air inlet opening 42 and the restriction 20 each form part of the apparatus 4. However, this is not requisite. It will be clear that the air inlet opening 42 and/or the restriction 20 can form part of the exchangeable holder 2.

After the beverage, in this example coffee with a fine-bubble froth layer, has been prepared, the control device 34 stops the fluid dispensing device 6. The control device 34 also ensures that the third fluid is no longer supplied to the second fluid in the storage space, and that the needle 28 is retracted from the respective wall of the storage space 8, i.e., in a direction opposite that of the arrow Pa. Here, it may be that the control device 34 first provides that the dispensing of the second fluid to the first mixing chamber is stopped and that after that, the supply of the first fluid (in this example water) is stopped. Thus, the risk of the second fluid contaminating, for instance, the restriction 20 is reduced.

FIG. 1c shows a situation where the needle 28 is pierced through a wall of the storage space 8 and the third fluid is supplied under pressure to the second fluid in the storage space 8. The situation shown occurs at the moment at which the control device 34 will stop the supply of hot water to the first mixing chamber 10, will no longer cause the third fluid to be supplied to the second fluid in the storage space 8, and will cause the needle 28 to be retracted from the respective wall of the storage space 8 so that the holder 2 may thereupon be taken from the apparatus 4 again.

After this, a user can remove the exchangeable holder 2 and, if a new amount of beverage is to be prepared, place a new exchangeable holder in the apparatus 4. The new exchangeable holder may be provided with an entirely different type of second fluid, such as, for instance, a milk concentrate. When, with the aid of the new exchangeable holder, milk is prepared in a manner comparable to that as described for the preparation of coffee based on coffee concentrate, no trace of the previously prepared type of beverage will be found in the milk prepared. The reason is that the first mixing chamber 10 forms part of the exchangeable holder and when a new exchangeable holder is placed in the apparatus 4, also an entirely new and hence clean first mixing chamber is placed in the holder. Accordingly, there can be no contamination involved.

In the example of FIGS. 1a-1c, the dosing device 24 is designed for supplying the third fluid under pressure to the second fluid in the storage space 8 for dispensing the second fluid in a dosed manner to the first mixing chamber 10. It will be clear that in addition or as an alternative, the dosing device 24 may be provided with a compression unit for compressing the storage space 8 for dispensing the second fluid to the first mixing chamber 10 in a dosed manner, as described, for instance, in WO 2006/043808.

In the example of FIGS. 1a-1c, the jet of the first fluid spouts into the first mixing chamber 10. It is possible that here, the jet strikes an inner wall of the first mixing chamber 10, whereby swirls are formed in the first mixing chamber 10, with the result that concentrate, the first fluid and optionally air are mixed together. It is also possible that the jet strikes a jet impact element in the first mixing chamber 10. Upon impact of the jet on the jet impact element, the liquid is atomized, allowing air to be properly beaten in.

Reference is now made to FIGS. 2a and 2b. The exchangeable holder 2, storage space 8, first mixing chamber 10, outflow opening 12, fluid communication 14, and inlet opening 16 shown in FIGS. 1a-1c, are indicated in the other FIGS. 2-5 as, respectively, the holder 102, the storage space 108, the first mixing chamber 110, the outflow opening 112, the fluid communication 114, and the inlet opening 116. Since the general operation of the holder and the system have already been described with reference to FIGS. 1a-1c, the description with reference to FIGS. 2-5 will be limited to the differences and further elaborations of the holder and the system.

FIG. 2a shows a top plan view of an exchangeable holder according to an embodiment of the invention. The holder 102 in this example comprises a blister package and may for instance be a disposable package, with a first portion 102a being preferably a deep-drawn part, for instance from a plastic, and a second portion (not shown) being a covering (see FIGS. 3-5) of, for instance, film.

The holder 102 has two storage spaces 108, 109, which both can comprise different second fluids, for instance concentrates, for instance a coffee concentrate and a milk concentrate for preparing for instance cappuccino or café au lait. It is noted that in the example shown, the holder 102 has two outflow openings 112.

The holder is further provided with a stop 117, against which a fluid supply element (not shown) of the fluid dispensing device 6 (see FIGS. 1a-1c) forming at least a part of the outlet opening 18 (see FIGS. 1-1c) abuts in use, such that in use the first fluid is supplied through the inlet opening 116 of the first mixing chamber 110 and then, along a certain path within the mixing chamber 110, does not hit any inner walls of the first mixing chamber. This will be clarified with reference to FIGS. 3a-3d.

Reference is now made to FIG. 2b, showing a partly perspective view of a holder 102 and the fluid supply element 118 forming at least a part of the outlet opening 18. The inlet opening 116 of the holder 102 also forms the inlet opening 116 of the first mixing chamber 110. The first mixing chamber 110 has an inner wall 111 which is situated opposite the inlet opening 116 of the first mixing chamber 110. This inner wall 111 is the inner wall of the first mixing chamber 110 which in this example, in use, i.e. when the fluid supply element 118 of the fluid dispensing device has been placed on the stop 117, is hit first by the entering first fluid. The entering fluid will in use strike against the wall 111 in the direction represented by arrow R2. Preferably, the inner wall 111 extends substantially perpendicularly to the direction of the path (direction R2) which the entering first fluid in use follows within the first mixing chamber 110. The path traveled in use by the first fluid in the first mixing chamber 110 preferably has a length of at least one-third of the length of the first mixing chamber 110 viewed in the direction R2 of the entering first fluid. The second fluid may already be present in the first mixing chamber 110 at entry of the first fluid or be simultaneously supplied to the first mixing chamber 110. As a result of the first fluid striking against the inner wall 111, swirls arise in the fluid, so that the fluid mixes properly, thereby forming a beverage of the desired quality. It is also possible that the inner wall 111 is positioned at a different location within the first mixing chamber for instance to obtain different whirls and/or other mixing properties. In use, the fluid supply element 118 is placed in direction R1 into the holder 102, such that a side 118a of the fluid supply element 118 situated opposite the stop lies on the stop 117 upon placement. The covering (not shown) may also be provided over the inlet opening 116. In that case, the fluid supply element 118, when the system is put into operation, is inserted through the sealing before it is positioned against the stop 117. The stop 117 comprises an abutment surface 117a which is arranged for receiving the side 118a of the fluid supply element 118 situated opposite the stop. The abutment surface 117a has substantially an equal shape and equal dimensions to the bottom side 118a of the fluid supply element 118, in this exemplary embodiment substantially round. The stop 117 is rigid in this exemplary embodiment and therefore retains its shape when the fluid supply element 118 is placed on the abutment surface 117a. In another embodiment, when the stop 117 is not rigid, a retainer member (not shown) may be provided in the apparatus 4 which in use is placed under the stop 117. Such a retainer member prevents the stop from deforming when the fluid supply element 118 is placed on the stop 117. In the fluid supply element 118a first fluid channel 119 is provided, through which fluid can be displaced from the fluid dispensing device to the outlet opening 18 of the fluid supply element 118.

Reference is now made to FIG. 3a, showing a schematic cross section A-A′ of an embodiment of the holder 102 and the fluid supply element 118. In FIG. 3a the position of the fluid supply element 118 and the holder 102 in use is represented. The side 118a of the element 118 that is situated opposite the stop lies on the abutment surface 117a of the stop 117 of the holder 102. The outlet opening 18 is situated opposite the inlet opening 116 of the holder 102, while, in use, using the outlet opening 18a jet of the first fluid is formed which spouts direct into the first mixing chamber 110. The stop 117 is therefore arranged for cooperating with the fluid supply element 118 forming the outlet opening 18. The stop 117 extends substantially parallel between a first wall 110a bounding the first mixing chamber and a second wall 110b of the first mixing chamber 110, situated opposite the first wall, bounding the first mixing chamber. Preferably, the distance h1 from a plane through the stop 117 to a plane through the first wall 110a of the first mixing chamber 110 is substantially equal to the distance h2 from the stop to the second wall 110b of the first mixing chamber 110. Since the jet flows into the first mixing chamber 110 approximately in the middle, what is prevented is that the fluid flows into the first mixing chamber 110 along the inner walls. Thus a proper mixing of the first and the second fluid is obtained. It is noted that the first wall 110a of the first mixing chamber 110 bounding the first mixing chamber is formed by the covering 199 and the second wall 110b of the first mixing chamber 110, bounding the first mixing chamber, is formed by a part 102a of the holder 102 remote from the covering. The nozzle 120 is provided adjacent an end of the first fluid channel 119 and is arranged to dispense the first fluid and supply it into the inlet opening 116 of the first mixing chamber 110. The nozzle 120 is formed by a groove 122 which is provided in the side 118a of the fluid supply element 118, situated opposite the stop, in this example substantially transversely to the fluid channel 119. It will be clear that the fluid channel can also extend at different angles relative to the groove. The groove extends from fluid channel 119 as far as an outermost side 118b of the fluid supply element 118. Such a nozzle 120 is easy to clean and will not readily clog up. The stop 117 is arranged for cooperating with a nozzle 120 of the fluid supply element 118, while the nozzle 120 may be formed at least for a part by a groove and/or channel provided in the fluid supply element 118. For this purpose, the stop 117 may be flat, so that the volume and the cross section of the nozzle 120 are determined entirely by the groove 122. However, as is shown in FIG. 3b, the stop 117 may be provided with a notch 125. In use, this notch 125 is situated opposite the groove 122 of the nozzle 120 in the side 118a of the fluid supply element 118 situated opposite the stop. The notch 125 has substantially identical circumferential edges to the groove 122. In this way, the volume and the cross section of the nozzle 120 are determined by the joint volumes and cross sections of the groove 122 and the notch 125, so that a larger nozzle 120 is formed. In this way, the nozzle 120 can be adjusted in such a way that the nozzle 120 is suitable for the concentrate present in the holder 102 and the associated beverage to be made. It is also possible that the stop 117 is not provided with a notch 125 but with a protrusion. In that case, the protrusion will reduce the volume and the cross section of the groove 122, so that a smaller nozzle 120 is obtained. By varying in notches and/or protrusions, the most suitable shape of the cross section and the size of the cross section of the nozzle 120 can be determined by the holder 102, for instance depending on the content thereof. A consumer therefore does not need to perform any extra operations after placing the holder 102 in the apparatus 4, since the holder 102 determines the size of the nozzle 120. In use, depending on the shape and size of the cross section of the nozzle 120, a jet of the first fluid is generated which is then spouted into the inlet opening 116. In the general description of FIGS. 1a-1c it has been described that a restriction 20 may be included in a fluid flow path 22. Alternatively, the nozzle 20 may form the restriction, but the restriction may also be provided in the nozzle 120 (not shown). The restriction can generate a jet, but also for instance a mist. It will be clear that any other shape of the entering first fluid can be determined by a particular restriction.

In FIG. 3c, another embodiment of the invention is shown. In this embodiment, the system is provided with a gas supply opening which is, or can be set, in fluid communication for supplying gas, such as air or CO₂, to the beverage in the system. The gas supply opening is formed by a second fluid channel 121 which is arranged for supplying for instance air to the fluid present in the first mixing chamber 110. The end of the second fluid channel 121, the outlet opening 123a, is situated above an end of the first nozzle 120 in the outermost sidewall 118b of the fluid supply element 118, viewed from the side 118a of the fluid supply element 118 situated opposite the stop 117. The second fluid channel 121 is likewise connected with the fluid dispensing device. As mentioned earlier in the description with reference to FIGS. 1a-1c, a control device may be provided for controlling the fluid dispensing device. This control device can control the fluid dispensing device for independently determining the pressure, amount and/or temperature of the first fluid and air which is operatively supplied to the first mixing chamber 110 depending on the desired beverage. The first fluid and the air can be supplied to the first mixing chamber 110 simultaneously or consecutively. The control device may control the fluid dispensing device depending on a code that may be provided on the holder 102.

In FIG. 3d, a further elaboration of the exemplary embodiment of FIG. 3c is represented. Provided slidably around the fluid supply element 118 is a closing means 124. This closing means 124 is slidable from an open position to a closed position in which one of the ends 18, 123a is closed. In this case, the outlet opening 123a of the second fluid channel 121 is closed, so that no air ends up in the first mixing chamber 110. Naturally, it is also possible to close off just the first fluid channel 119, so that only air is supplied to the first mixing chamber 110. For bringing the closing means 124 either in an open or in a closed position, a cam 125 is provided on the stop 117. This cam 125 stops the closing means 124 in part when the fluid supply element 118 is being placed on the stop 117. Clearly, by variation in the cam 25, different positions of the closing means 124 can be obtained. It is also possible to incorporate the setting of the closing means 124 into an open or closed position in the earlier-mentioned code on the holder. The control device can then on the basis of this information in the code control the closing means as well. In that case, no cam 125 needs to be provided on the stop 117. It will be clear that it is also possible for the closing means to close off both ends 18, 123a, for instance in an inoperative condition, for instance to prevent contamination.

Such a closing means may also be provided in the embodiment of the invention as represented in FIGS. 4a and 4c. In this embodiment of the invention, the two fluid channels 119, 121 extend in a same plane and the respective nozzles 120, 123 are situated substantially next to each other, viewed from the side 118a of the fluid supply element 118 situated opposite the stop. The second nozzle 123 in this exemplary embodiment is formed by a groove which in this example extends substantially transversely to the second fluid channel 121 and runs approximately parallel to the first nozzle 120. A similar closing means to that represented in FIG. 3d, which may work similarly, may in this case be provided rotatably around the fluid supply element 118 (not shown). This closing means may also be brought into an open or closed position by e.g. a cam which is provided on the stop 117 or by the control device which is controlled by information on the position of the closing means that is included in a code provided on the holder.

In FIG. 4b, a perspective bottom view of a further embodiment of the invention is shown, in which the end of the second fluid channel 121 is in fluid communication with the first nozzle 120 which is connected with the first fluid channel 119. In this way, only one outlet opening 18 is needed for simultaneously supplying the first fluid and air to the first mixing chamber 110. Such a fluid communication between the second fluid channel 121 and the nozzle 120 can be closed in a simple manner with a closing cam (not shown) which may be provided on the stop 117, if supply of air to the first mixing chamber 110 is unwanted, for instance when preparing a frothless beverage such as tea.

In FIG. 4c, a perspective view of the stop 117 is shown, where two notches 125, 126 are provided which in use are situated opposite the grooves of the first nozzle 120 and the second nozzle 123, while in this example the circumferential edges of the notches 125, 126 substantially connect to the respective circumferential edges of the grooves of the nozzles 120, 123. In this way, two enlarged nozzles are obtained. Naturally, instead of notches 125, 126, also protrusions may be provided as described earlier with reference to FIG. 3b. By variation in the size of the nozzles 120, 123, both a beverage with a slight froth layer can be prepared, viz. if the nozzle 123 for air is relatively small, and a frothy beverage if the nozzle 123 for air is relatively large.

Finally, FIG. 5 shows an embodiment of the invention in which a sealing 128 is provided between the side 118a of the fluid supply element 118 situated opposite the stop, and the side of the stop 117 situated opposite the fluid supply element, the abutment surface 117a, for fluid-tight closure of the fluid supply element 118 on the holder 102. This sealing 128 prevents leakage of air and/or the first fluid, such as hot water or steam, outside the fluid flow path 22 (see FIGS. 1a-1c). This sealing comprises a sealing groove 129 which is provided adjacent the circumferential edge of the stop 117 and a sealing edge 130 which fits in the sealing groove 129, the sealing edge 130 extending adjacent the circumferential edge of the side 118a of the fluid supply element 118 situated opposite the stop. The sealing 128 may also comprise a groove 129 on the side 118a of the fluid supply element 118 situated opposite the stop, and an edge 130 on the stop 117. Also other forms of sealings provided between the fluid supply element 118 and the stop 117 are options.

It will be clear that the invention is not limited to the exemplary embodiment described. Various modifications are possible within the framework of the invention as set forth in the appended claims. The stop of the exchangeable holder may for instance be provided with at least one groove and/or channel for forming at least one nozzle, arranged for operatively cooperating with a fluid channel that is provided in the fluid supply element. The groove and/or the channel is then provided in a side of the stop situated opposite the fluid supply element, substantially transversely to the fluid channel, and extends from the fluid channel to the inlet opening. In such an embodiment of the holder, it is not necessary that a groove is provided in the fluid supply element. The fluid supply element can therefore be made of relatively simple design and along with the exchangeable holder the nozzle is replaced, so that it does not need to be cleaned. Evidently, the nozzle may be formed in the stop by merely a groove, merely a channel or a combination of a groove and a channel, extending from an end of the at least one fluid channel to the inlet opening of the first mixing chamber to spout fluid into the first mixing chamber. Further, it is clear that different shapes of the groove and/or the channel also belong to the invention.

Further, an exchangeable holder, instead of comprising one or two storage spaces for a further second fluid, may also comprise more than two storage spaces for several possibly different second fluids. The second fluids may for instance be miscible with and/or soluble in the first fluid. In the example, the storage spaces were filled with coffee concentrate and/or milk concentrate. Other fluids, whether or not based on concentrate, are also conceivable. To be considered here, for instance, are a squash or powder for preparing a lemonade. When through the second fluid channel of the fluid supply element CO₂ is supplied to the first mixing chamber, a carbonated lemonade can be prepared. The apparatus may further be provided with additional storage spaces which may for instance be filled with additives such as, for instance, soluble powders or concentrates. These powders too may be supplied to the first mixing chamber for instance through displacement using a third fluid, or by emptying the respective storage space through squeezing. Here, for instance, flavor enhancers, sugars, cocoa and the like can be involved. Also, milk powder and/or milk creamer can be considered. Generally, it holds that the second fluid, apart from being a liquid such as a concentrate, can also be a powder and the like, which is for instance soluble in the first fluid or miscible with the first fluid, for instance soluble in a liquid such as water. Also, a second fluid in the storage space may comprise both a concentrate and a powder, whether or not in mixed form.

Such variants are each and all understood to fall within the framework of the invention. The temperature of the first fluid can vary. For instance, the first fluid can also consist of water at room temperature, or cold water. Also, the temperature of the first fluid which is supplied to the holder for preparing a beverage may vary over time. Further, the gas supply opening may be arranged for supplying air or CO₂ to the first mixing chamber. However, it is also possible for steam to be supplied to the first mixing chamber through the gas supply opening. The control device can control the fluid dispensing device for dispensing the first fluid and/or the gas to the first mixing chamber through the fluid supply element, but may also control any closing means for closing at least one outlet opening. The control device can also control the fluid supply element for the positioning thereof on the stop.

The volume of a storage space may for instance vary from 5 to 150 ml, more particularly from 6 to 50 ml. A passage opening of the restriction can for instance vary from 0.4 to 1.5 mm, more particularly from 0.6 to 1.3 mm, still more particularly from 0.7 to 0.9 mm. The pressure at which, in use, the liquid dispensing device dispenses the first fluid can vary from 0.6 to 12 bar, more particularly from 0.7 to 2 bar, preferably from 0.9 to 1.5 bar. The period during which the first fluid is supplied to the first mixing chamber for preparing the beverage can vary from 2 to 90 seconds, more particularly from 10 to 50 seconds. The size of the air inlet opening, when this is fully opened, can vary from, for instance, 0.005 to 0.5 mm².

1. A system for preparing a predetermined amount of beverage suitable for consumption, the system comprising:
an exchangeable holder, and
an apparatus having a fluid dispensing device which is detachably connected with the holder for in use dispensing under pressure at least an amount of first fluid such as a liquid and/or a gas, in particular such as water and/or steam, to the exchangeable holder,
wherein the exchangeable holder is includes:
at least one storage space which is filled with a second fluid such as a concentrate,
at least a first mixing chamber,
at least one outflow opening which is in fluid communication with the first mixing chamber for dispensing the beverage from the first mixing chamber, wherein in use at least one fluid communication between the storage space and the first mixing chamber for dispensing the second fluid to the first mixing chamber is present,
at least one inlet opening which in use is detachably connected with an outlet opening of the fluid dispensing device for supplying the first fluid to the first mixing chamber, wherein the fluid dispensing device is arranged for supplying the first fluid under pressure to the first mixing chamber, so that in the first mixing chamber the first fluid and the second fluid mix together for obtaining beverage which thereupon leaves the exchangeable holder via the outflow opening,
a stop against which a fluid supply element of the fluid dispensing device forming at least a part of the outlet opening abuts in use, such that in use the first fluid is supplied through the inlet opening of the holder into the first mixing chamber and then, along a certain path within the first mixing chamber, does not hit any inner walls of the first mixing chamber.

2. A system according to claim 1, wherein in use the outlet opening is situated in front of the inlet opening of the holder, while using the outlet opening a jet of the first fluid is formed which spouts direct into the first mixing chamber.

3. A system according to claim 1, wherein the inlet opening of the holder also forms an inlet opening of the first mixing chamber.

4. A system according to claim 1, wherein the certain path that the first fluid travels in the first mixing chamber has a length of at least one-third of a length of the first mixing chamber viewed in the direction of the entering first fluid.

5. A system according to claim 3, wherein the first mixing chamber has an inner wall which is situated opposite the inlet opening of the first mixing chamber, which inner wall of the first mixing chamber is hit first by the entering first fluid.

6. A system according to claim 5, wherein the inner wall extends substantially perpendicularly to the direction of the path that the entering first fluid follows within the first mixing chamber.

7. A system according to claim 1, wherein the stop extends substantially parallel between a first wall bounding the first mixing chamber and a second wall, situated opposite the first wall, bounding the first mixing chamber, while preferably a distance from the stop to the first wall and a distance from the stop to the second wall are substantially equal.

8. A system according to claim 1, wherein the stop extends substantially parallel to a first wall bounding the first mixing chamber and a second wall, situated opposite the first wall, bounding the first mixing chamber, while preferably a distance from a plane through the stop to a plane through the first wall is substantially equal to a distance from the plane through the stop to a plane through the second wall.

9. A system according to claim 1, wherein the outlet opening is formed at least for a part by a fluid supply element, provided on the apparatus, having a first fluid channel, while in use adjacent an end of the fluid channel a first nozzle is provided for dispensing the first fluid.

10. A system according to claim 9, wherein the first nozzle is formed at least for a part by a groove and/or channel, provided in a side of the stop situated opposite the fluid supply element, substantially transversely to the fluid channel, while the groove and/or the channel extends from the fluid channel to the inlet opening.

11. A system according to claim 9, wherein the first nozzle is formed at least for a part by a groove, which is provided in a side of the fluid supply element situated opposite the stop, substantially transversely to the fluid channel, and a side of the stop situated opposite the fluid supply element, the groove extending from the fluid channel as far as an outermost side of the fluid supply element.

12. A system according to claim 1, wherein the stop comprises an abutment surface which has substantially an equal shape and equal dimensions to the side of the fluid supply element situated opposite the stop.

13. A system at least according to claim 11, wherein the stop is provided with a notch or a protrusion, which notch or protrusion is situated substantially opposite the groove in the side of the fluid supply element situated opposite the stop and substantially connects to circumferential edges of the groove for forming a larger or smaller nozzle, respectively.

14. A system according to claim 1, wherein the system is provided with at least one gas supply opening which is, or can be set in, fluid communication for supplying gas, such as air or CO₂, to the beverage in the system.

15. A system according to claim 9, wherein the gas supply opening is formed by a second fluid channel provided in the fluid supply element, wherein the first fluid channel is arranged for supplying the first fluid, for instance water or steam, while the second fluid channel is arranged for supplying gas, such as air or CO₂.

16. A system according to claim 15, wherein an end of the second fluid channel is situated substantially above an end of the first nozzle in an outermost sidewall of the fluid supply element viewed from the side of the fluid supply element situated opposite the stop.

17. A system according to claim 15, wherein slidably around the fluid supply element a closing means is provided, which closing means is slidable from an open position in which the end of the second fluid channel and the end of the first nozzle are open, to a closed position in which one of the ends is closed in order to supply only the first fluid to the first mixing chamber or to supply only gas, such as air or CO₂, to the first mixing chamber, respectively.

18. A system according to claim 17, wherein the stop is provided with a cam, the cam being arranged to bring the closing means in use to a desired position and to keep same in a desired position.

19. A system according to claim 15, wherein an end of the second fluid channel is situated in a same plane in which the first fluid channel extends and is situated adjacent the end of the first fluid channel.

20. A system according to claim 15, wherein an end of the second fluid channel is in fluid communication with the first nozzle.

21. A system according to claim 20, wherein the stop comprises a closing cam which in use at least partly closes off the fluid communication between the second fluid channel and the first nozzle.

22. A system according to claim 21, wherein adjacent the end of the second fluid channel a second nozzle is provided for dispensing gas, such as air or CO₂, to the first mixing chamber.

23. A system according to claim 22, wherein the second nozzle is formed at least for a part by a groove and/or channel, provided in a side of the stop situated opposite the fluid supply element, substantially transversely to the second fluid channel, while the groove and/or the channel extends from the second fluid channel to the inlet opening, the first and second nozzles being situated substantially next to each other viewed from the side of the stop situated opposite the fluid supply element.

24. A system according to claim 22, wherein the second nozzle is formed at least for a part by a groove which is provided in a side of the fluid supply element situated opposite the stop, substantially transversely to the second fluid channel, and a side of the stop situated opposite the fluid supply element, while the groove extends from the fluid channel as far as an outermost side of the fluid supply element, while the nozzles are situated substantially next to each other viewed from the side of the fluid supply element situated opposite the stop.

25. A system according to claim 22, wherein, rotatably around the fluid supply element, a closing means is provided which is rotatable from an open position, in which an end of the second nozzle and an end of the first nozzle are open, to a closed position in which one of the ends is closed to supply only the first fluid to the first mixing chamber or to supply only gas, such as air or CO₂, to the first mixing chamber, respectively.

26. A system according to claim 24, wherein the stop comprises at least one of a notch and/or a protrusion, which in use is situated opposite at least one of the grooves of the first and second nozzles, while the at least one notch and/or protrusion substantially connects to circumferential edges of the respective grooves for enlarging, reducing or closing off the at least one nozzle.

27. A system according to claim 1, wherein between the side of the fluid supply element situated opposite the stop and the side of the stop situated opposite the fluid supply element, a sealing is provided.

28. A system according to claim 27, wherein the sealing comprises at least one sealing groove and a sealing edge fitting in the sealing groove, wherein the sealing groove extends adjacent the circumferential edge of the side of the fluid supply element situated opposite the stop, and the sealing edge extends adjacent the circumferential edge of the side of the stop situated opposite the fluid supply element, or vice versa.

29. A system according to claim 1, wherein the system is further provided with a control device for controlling the fluid dispensing device.

30. A system according to claim 29, wherein the control device is arranged such that the fluid dispensing device independently supplies the first fluid and the gas to the first mixing chamber.

31. A system according to claim 1, wherein the system is further provided with a restriction which is included in a fluid flow path extending via the outlet opening and the inlet opening from the fluid dispensing device to the first mixing chamber.

32. A system according to claim 31, wherein the restriction is provided in the at least one nozzle.

33. A system according to claim 31, wherein the restriction is designed such that, in use, with the restriction, a jet of the first fluid is generated which spouts into the first mixing chamber.

34. A system according to claim 31, wherein the restriction is designed such that, in use, with the restriction, a mist of the first fluid is generated which flows into the first mixing chamber.

35. A system according to claim 1, wherein the holder is provided with a code and the apparatus is provided with a code reading unit for reading the code and a control device which controls the apparatus depending on the code read.

36. A system according to claim 35, wherein the control device, depending on the code read by the code reading unit, controls the fluid dispensing device to determine the pressure, amount and/or temperature of the first fluid and/or gas which, in use, is supplied to the holder.

37. A system according to claim 1, wherein the stop is rigid.

38. A system according to claim 1, wherein, in use, under the stop, a retainer member is provided, such that when the fluid supply element is situated on the stop, the stop cannot deform.

39. A system according to claim 1, wherein the inlet opening of the holder is provided with a sealing, for instance a seal, while in use the fluid supply element is inserted through the removable sealing before being positioned against the stop.

40. A system according to claim 1, wherein the holder comprises a blister package.

41. A system according to claim 1, wherein the holder comprises a disposable package.

42. An exchangeable holder arranged to be connected with an apparatus provided with a fluid dispensing device for in use dispensing under pressure at least a first fluid such as a gas and/or liquid to the exchangeable holder for preparing a beverage suitable for consumption, the exchangeable holder comprises:
at least one storage space which is filled with a second fluid such as a concentrate,
at least a first mixing chamber,
at least one outflow opening which is in fluid communication with the first mixing chamber for dispensing the beverage from the first mixing chamber, wherein in use at least one fluid communication between the storage space and the first mixing chamber for dispensing the second fluid to the first mixing chamber is present,
at least one inlet opening which, in use, is detachably connected with an outlet opening of the fluid dispensing device for supplying the first fluid to the first mixing chamber, wherein the fluid dispensing device is designed for supplying the first fluid under pressure to the first mixing chamber, so that in the first mixing chamber the first fluid and the second fluid mix together for obtaining the beverage which thereupon leaves the holder via the outflow opening,
a stop against which a fluid supply element of the fluid dispensing device forming at least a part of the outlet opening abuts in use, such that in use the first fluid is supplied through the inlet opening of the holder into the first mixing chamber and then, along a certain path within the first mixing chamber, does not hit any inner walls of the first mixing chamber.

43. A holder according to claim 42, wherein the certain path that the first fluid travels in use in the first mixing chamber has a length of at least one-third of a length of the first mixing chamber viewed in the direction of the entering first fluid.

44. A holder according to claim 42, wherein the inlet opening of the holder also forms an inlet opening of the first mixing chamber.

45. A holder according to claim 42, wherein the stop is arranged for cooperating with the fluid supply element forming the outlet opening, such that a jet of the first fluid formed by the outlet opening spouts into the first mixing chamber.

46. A holder according to claim 44, wherein the first mixing chamber has an inner wall which is situated opposite the inlet opening of the first mixing chamber, which inner wall, in use, is hit first by the entering first fluid.

47. A holder according to claim 46, wherein the inner wall extends substantially perpendicularly to the direction of the path which the entering first fluid in use follows within the first mixing chamber.

48. A holder according to claim 42, wherein the stop extends substantially parallel between a first wall bounding the first mixing chamber and a second wall, situated opposite the first wall, bounding the first mixing chamber, while preferably a distance from the stop to the first wall and a distance from the stop to the second wall are substantially equal.

49. A holder according to claim 42, wherein the stop extends substantially parallel to a first wall bounding the first mixing chamber and a second wall, situated opposite the first wall, bounding the first mixing chamber, while preferably a distance from a plane through the stop to a plane through the first wall is substantially equal to a distance from the plane through the stop to a plane through the second wall.

50. A holder according to claim 42, wherein the stop is arranged for cooperating in use with a nozzle formed at least for a part by a groove and/or channel provided in the fluid supply element.

51. A holder according to claim 42, wherein the stop comprises an abutment surface which is arranged for receiving in use the side of the fluid supply element situated opposite the stop, which side has substantially an equal shape and equal dimensions to the abutment surface.

52. A holder according to claim 42, wherein the stop is provided with at least one groove and/or channel arranged for cooperating in use with a fluid channel which is provided in the fluid supply element, the groove and/or the channel being provided in a side of the stop situated opposite the fluid supply element, substantially transversely to the fluid channel, while the groove and/or the channel extends from the fluid channel to the inlet opening.

53. A holder according to claim 42, wherein the stop is provided with at least one notch and/or one protrusion, which notch or protrusion in use is situated substantially opposite a groove of the nozzle in the side of the fluid supply element situated opposite the stop, while the notch and/or the protrusion has substantially equal circumferential edges to the groove of the nozzle, for forming a larger or smaller nozzle, respectively.

54. A holder according to claim 53, wherein the stop comprises several notches and/or protrusions which are arranged for cooperating in use with several opposed grooves of nozzles, wherein the notches and/or protrusions substantially connect to circumferential edges of the respective grooves for enlarging, reducing or closing off the nozzles.

55. A holder according to claim 42, wherein the stop is provided with a cam, the cam being arranged for operatively bringing a closing means provided around the fluid supply element to a desired position and keeping same at a desired position.

56. A holder according to claim 50, wherein the stop comprises a closing cam which is arranged for operatively at least partly closing a fluid communication between a fluid channel and the nozzle of the fluid supply element.

57. A holder according to claim 42, wherein on a side of the stop situated opposite the fluid supply element, a sealing part is provided for cooperating with a sealing part that is provided on a side of the fluid supply element situated opposite the stop.

58. A holder according to claim 57, wherein the sealing part comprises a sealing groove which extends adjacent the circumferential edge of the side of the stop situated opposite the fluid supply element and which is arranged for receiving a sealing edge fitting in the sealing groove.

59. A holder according to claim 57, wherein the sealing part comprises a sealing edge which extends adjacent the circumferential edge of the side of the stop situated opposite the fluid supply element and which is receivable in a sealing groove.

60. A holder according to claim 42, wherein the holder is provided with a code which can be read with a code reading unit.

61. A holder according to claim 42, wherein the inlet opening is provided with a removable sealing such as a seal.

62. A holder according to claim 42, wherein the stop is rigid.

63. A holder according to claim 42, wherein the holder comprises a blister package.

64. A holder according to claim 42, wherein the holder comprises a disposable package.

65. An apparatus for use in a system according to claim 1.
